(19) United States
(12) Patent Application Publication
(10) Pub. No.: US 2018/0219935 A1
(43) Pub. Date: Aug. 2, 2018

(54) SYSTEMS AND METHODS FOR DYNAMIC CONTENT DELIVERY TO MOBILE COMPUTING DEVICES BASED ON CONTEXTUAL PRESENTATION OF WORKFLOW

(71) Applicant: General Electric Company, Schenectady, NY (US)

(72) Inventors: Ching-Ling HUANG, San Ramon, CA (US); Bo YU, Dublin, CA (US); Raju VENKATARAMANA, Dublin, CA (US)

(21) Appl. No.: 15/417,574

(22) Filed: Jan. 27, 2017

(51) Int. Cl. H04L 29/08; H04W 72/12

(52) U.S. Cl. CPC H04L 67/04; H04L 67/306; H04W 72/12

(57) ABSTRACT

A method for contextual content delivery of workflow management system information to a mobile computing device includes registering in a data record each mobile computing device accessible to a respective user, applying device selection rules in combination mobile computing device with specific information, constructing a real-time context model, receiving task information content to be sent to the respective user, retrieving device association rules, fitting criteria of the device association rules to the real-time context model, selecting a context model for delivery of the task information content, delivering the task information content to at least one mobile computing device accessible to the respective particular user, and updating the task information content delivery based on latest mobile computing devices detected, their specific information, and the next workflow task. A system configured to implement the method and a non-transitory computer-readable medium containing instructions for a processor to perform the method are also disclosed.

### BACKGROUND

A conventional workflow management system (WFMS) can provide users with information for setting up, performing, and monitoring processes in a pre-defined sequence of stages. Different workflow processes can be defined in a WFMS by the user—for example, manufacturing assembly, document generation and review, troubleshooting and repair, etc.

A WFMS can track progress of a workflow, register completion of a stage, and notify the user(s) of a next stage as the workflow process progresses. The WFMS can notify the user(s) of data needed for the execution of the stage in advance of its execution.

Conventional WFMSs are designed for delivering content in very specific contexts to a specific device platform—i.e., a desktop computer, or a or mobile phone. This delivery platform limitation is inadequate for present day work environments where users have dynamic access to a variety of mobile computing device types. Because of changing conditions, the context of a workflow process can vary during the workflow execution, and the WFMS needs to be adaptable to deliver content for these varied contexts.

### BRIEF DESCRIPTION OF THE DRAWINGS

FIG. 1 depicts a system for context-sensitive, device-agnostic content delivery in accordance with embodiments;

FIG. 2 depicts a mobile computing device taxonomy in accordance with embodiments;

FIG. 3 depicts associations between taxonomy elements of FIG. 2 and workflow processes in accordance with embodiments; and

FIG. 4 depicts an exemplary workflow visualization supportable by a high level mobile computing device in accordance with embodiments;

FIG. 5 depicts an exemplary workflow visualization supportable by a low level mobile computing device in accordance with embodiments; and

FIG. 6 depicts a process for context-sensitive, device-agnostic content delivery in accordance with embodiments.

### DETAILED DESCRIPTION

Embodying systems and methods enhance a dynamic WFMS with the ability to provide a context-sensitive, device-agnostic (i.e., machine independent), user experience optimized for content delivery. Embodying systems include a device registration unit to seamlessly register existing and new mobile computing devices to a WFMS, a real-time context model unit that can represent the operating state and environment of end users, and a monitoring and inference engine unit that interfaces with both the device registration unit and the real-time context model unit to deliver workflow content with a context that optimizes the end user's experience. Embodying systems and methods support the seamless entrance and/or exit of mobile computing devices from the WFMS independent of the nature and/or type of mobile computing device.

The term “mobile computing device” refers to tablets, smart phones, wearable computing devices (watch, eyeglasses, head mounted devices, etc.), touch screen monitors, gesture-controlled devices, etc. Embodying systems and methods are not so limited to just these types of mobile computing devices. Current and/or future mobile computing device types are within the scope of this disclosure.

Embodying systems and methods can access mobile computing device specific protocols that can be dependent on the type, capability and/or attributes of various mobile computing devices available for use by end users of the WFMS. Based on the mobile computing device's specific protocol, embodying systems and methods deliver workflow content to the end user in a context that can optimize the user's experience.

Embodying systems and methods extend WFMS capability to support a variety of mobile computing devices available today, as well as future mobile computing devices. In accordance with embodiments, existing WFMS can be extended to incorporate the environmental context of the content in determinations of what and how to deliver the content to the end user.

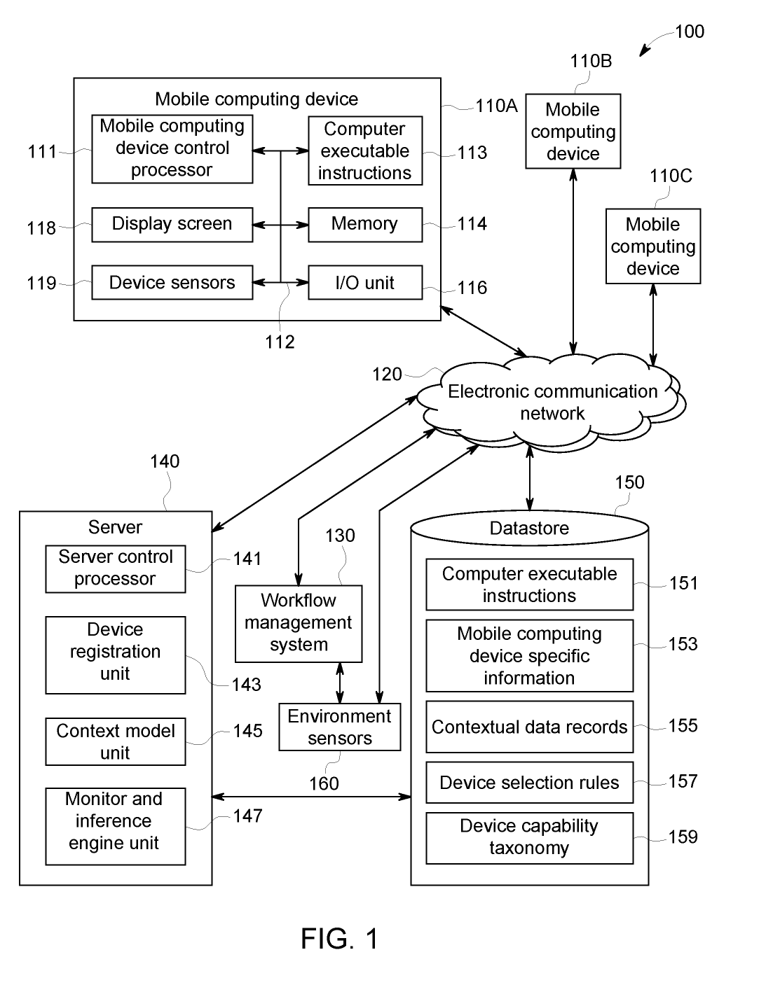

FIG. 1 depicts system 100 for context-sensitive, device-agnostic content delivery to a user of a WFMS 130 in accordance with embodiments. An embodying system can include one or more mobile computing device(s) 110A, 110B, 110C. In accordance with embodiments, each mobile computing device can be the same type, or a different type (e.g., tablets, smart phones, wearable computing devices, touch screen monitors, gesture-controlled devices, etc.). An end user of embodying systems is not limited to using just one type of mobile computing device, but can switch between devices based on any number of factors (e.g., changes in user location, changes in user task, etc.).

Each mobile computing device can include control processor 111 that communicates with other components over internal data/control bus 112. Control processor 111 accesses computer executable instructions 113, which can be stored in memory 114. Mobile computing device 110A, 110B, 110C can include display screen 118 for the display of content delivered from a WFMS. Device sensor(s) 119 can monitor current conditions regarding the state of the mobile computing device (e.g., accelerometers, gyros, ambient temperature, etc.). The mobile computing device can include input/output (I/O) unit 116 that communicates across electronic communication network 120. I/O unit 116 can support one or more hardwire and/or wireless communication protocols including, but not limited to, cellular telephone protocol, Bluetooth, low energy Bluetooth, iBeacon, near field communication, Airplay, etc.

Electronic communication network 120 can be, can comprise, or can be part of, a private internet protocol (IP) network, the Internet, an integrated services digital network (ISDN), integrated services digital network (ISDN), a modem connected to a phone line, a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding, and/or any other suitable communication infrastructure. It should be recognized that techniques and systems disclosed herein are not limited by the nature of electronic communication network 120.

Coupled to electronic communication network 120 can be server 140, which can include server control processor 141. Operation, communication and other functions of the server can be performed under the control of server control processor 141. Communicatively coupled to the server is datastore 150 where computer executable instructions 151 can be stored. The server control processor can access computer executable instructions 151 to perform its operations.

Datastore 150 can include a repository of data records. Communication with datastore 150 can be across electronic communication network 120. In some implementations, server 140 can be in direct communication with datastore 150. The datastore can include mobile computing device specific information 153 containing records of device specific communication protocols and capabilities.

Contextual data records 155 can include details that relate the mobile computing device user to the WFMS—for example, these details can include the present state of the user (e.g., walking, talking, performing a task, etc.), the user's present environment (e.g., office, facility floor (noisy, heavy machinery, fire, etc.), etc.), and/or the type of content to be delivered by the WFMS (e.g., warning, information, instructions, etc.). Contextual information can also include environmental factors (e.g., current local, or remote, weather, air temperature, humidity, barometric pressure, ambient noise level, time, etc.).

In accordance with embodiments, server 140 can include device registration unit 143 that can interface with conventional WFMSs and enable mobile computing device management and integration. The device registration unit can extend the support of WFMS to additional mobile computing devices for access by a user to the WFMS.

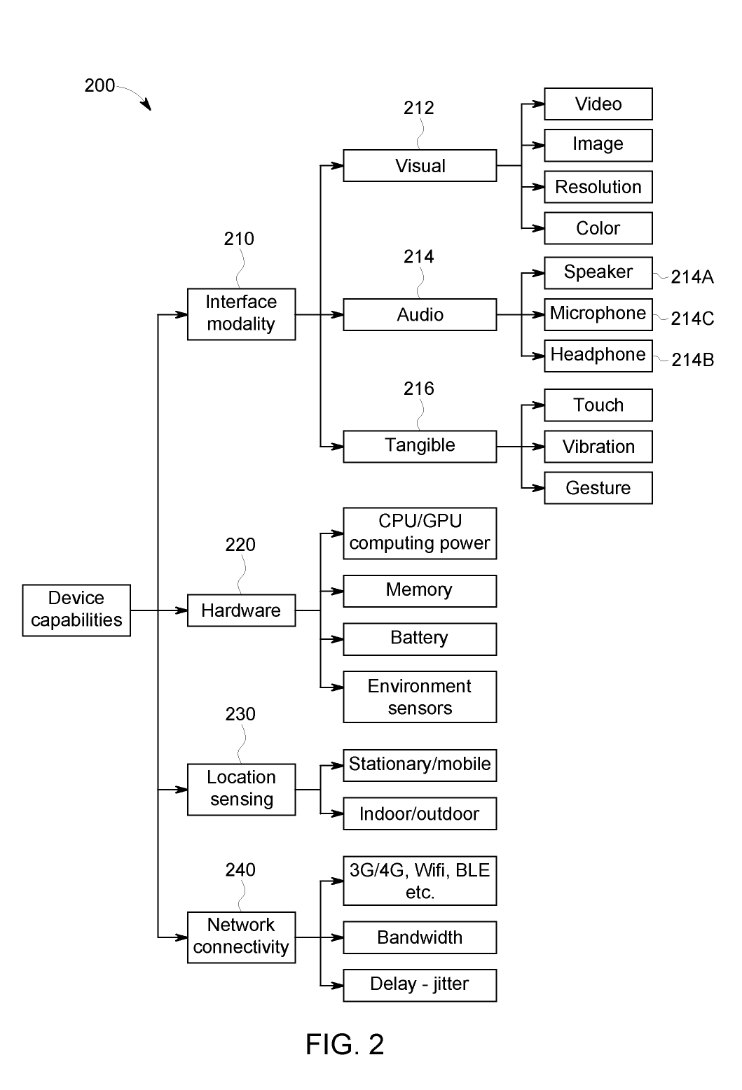

In accordance with embodiments, device registration unit 143 can access device capability taxonomy 159 that includes, and can be updated to include, mobile computing device types as each is registered with system 100. FIG. 2 depicts mobile computing device taxonomy 200 in accordance with embodiments. Taxonomy 200 is an example of a mobile device taxonomy. Embodying systems and methods are not limited to the specific illustrated taxonomy, and other taxonomies are within contemplation of this disclosure.

Taxonomy 200 is illustrated as a hierarchical tree with four exemplar parallel branches of capabilities (interface modality 210, hardware 220, location sensing 230, and network connectivity 240). Each of capabilities 210, 220, 230, 240 can be categorized by relevant attributes—e.g., interface modality 210 can include such attributes as visual 212, audio 214, and tangible 216 capabilities. Further, each of the attributes can be identified by the particular capability—for example, a mobile computing device's audio attribute 214 can include speaker 214A, headphone 214B and/or microphone 214C. FIG. 2 illustrates a taxonomy of capabilities for hardware 210, location 230, and network connectivity 240.

In accordance with embodiments, device registration unit 143 can include support of a dynamic user interface where system administrators can specify the major types of information, tasks, and specific requirements for mobile computing devices that can be used to deliver the WFMS information and/or content. Associations between workflow processes and the capabilities of the mobile computing device can be specified. Information, content, and/or task instruction from the WFMS can be delivered to the end user in a variety of different ways based on the different capabilities of the supported mobile computing devices.

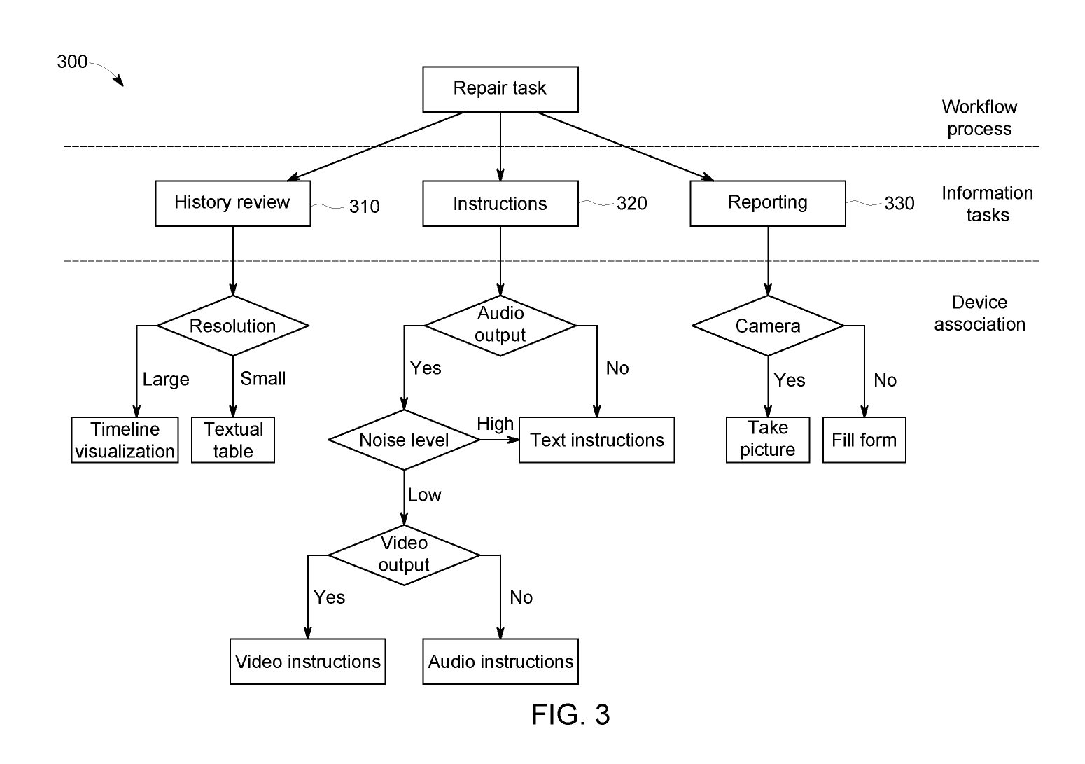

FIG. 3 depicts turbine repair workflow associations 300 between taxonomy elements and workflow processes in accordance with embodiments. Embodying systems and methods are not limited to the specific illustrated associations, and other associations are within contemplation of this disclosure.

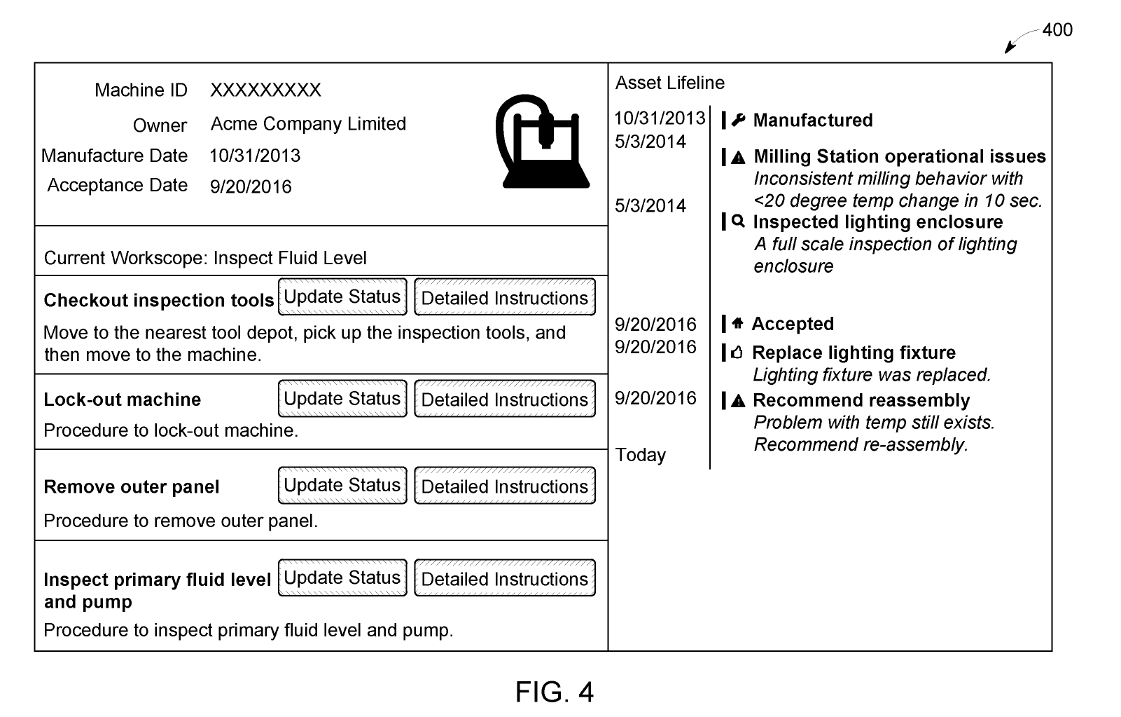

For example, a turbine repair task workflow process can be supported by three types of information tasks: history review task 310, instruction task 320, and report task 330. These information tasks can be performed in different ways based on the different capabilities of the supported mobile computing devices. If a user is in communication with the WFMS on a device with sufficient display area and graphical processing power (e.g., a laptop web browser, tablet, etc.), the entire repair history can be visualized on the device's display area using a timeline widget that can include interactive navigation. FIG. 4 depicts exemplary workflow visualization 400 that can be supported by a higher level mobile computing device in accordance with embodiments.

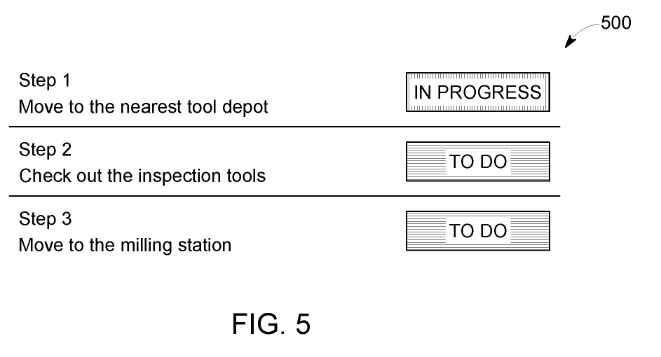

In another example, a mobile computing device with a more limited display area and lower graphical processing power (e.g., a wearable computing device), the repair history is displayed as a textual table, with a limited number of recent activities displayed (for example, the last ten results, or some other default amount). FIG. 5 depicts exemplary workflow visualization 500 that can be supported by a lower level mobile computing device in accordance with embodiments. FIG. 3 depicts associations between other types of information tasks and mobile computing device capabilities, along with resulting content delivery options.

With regard to FIG. 1, in accordance with embodiments, context model unit 145 can access contextual data records 155 (e.g., environmental data from environment sensors 160, a user's present state, and more) along with device selection rules 157, and device capability taxonomy 159 to construct real time context models. These real time context models can capture the state of an end user (e.g., a field engineer on a factory shop floor) and the environmental factors in which the end user is operating.

The real time context model constructed by context model unit 145 can integrate information from the WFMS, device sensors 119 (which can be stored in contextual data records 155), and environment sensors 160. The context in which the end user is immersed (e.g., location, proximity to equipment and tools, etc.) can be determined by interpolating and combining the information from these sources. In addition, the WFMS can provide contextual information about the end user tasks needed to be performed, including current task at hand, scheduled tasks, resource allocation, etc. All these factors can be combined by the context model unit 145 in constructing the context model.

In accordance with embodiments, monitor and inference engine unit 147 communicates with device registration unit 143 and context model unit 145 to determine the device (from among the user's mobile computing devices) and user experience to optimize the content delivery. The device selection is based on the present state of the end user (e.g., walking, talking, performing a task, etc.), the present environment in which the user is operating (e.g., noisy, heavy machinery, limiting weather conditions), and the type of content that the WFMS needs delivered at that moment (e.g., warning, information, instructions). Device selection rules 157 can include rules that are used by monitor and inference engine unit 147 in deciding what content can be delivered to various types of mobile computing devices based on their respective capabilities.

Multiple mobile computing devices can be used at the same time. However, based on their capabilities, some mobile computing devices might not be selected to receive certain content. A user can have access to more than one mobile computing device at the same time. A decision can be made to determine the content that is delivered to one, all, or a subset of these devices. For example, a wearable smart watch could have a small screen. The wearer can also have a tablet, which has a larger screen. Device selection rules 157 can be applied to select which content is rendered and delivered to which of these two devices (e.g., a brief task description on the smart watch screen, and detailed task information along with a figure to the tablet).

Monitor and inference engine unit 147 can detect potential context changes due to changes in contextual data records 155, mobile computing device sensors 119, and environmental sensors 160. The monitor and inference engine unit can optimize the information flow and content delivery to each mobile computing device supporting all end-users. The context monitoring and inference engine unit can track the current state of the context model in order to pick the optimal mobile computing device for delivering information (from among the mobile computing devices accessible to the particular user).

Monitor and inference engine unit 147 uses information about the state of the context model in a holistic manner by considering multiple factors, including but not limited to the state of the context model, current workflow, device capabilities, etc. Then the monitor and inference engine unit can select the optimal content delivery to the mobile computing device(s). The monitor and inference engine unit can integrate information regarding various contextual factors with association rules defined within the WFMS to decide the appropriate mobile computing device for delivering specific information content. Whenever an information task is triggered in the workflow, the monitor and inference engine unit 147 retrieves the device association rules from the WFMS and matches them with the current status expressed by the context model to decide on the right information format for the mobile computing device to display. In accordance with implementations, machine learning algorithms can be used to integrate and analyze the various input data sources in real time to determine probabilities of potential issues. These probabilities can then be incorporated into the mobile computing device selection determination.

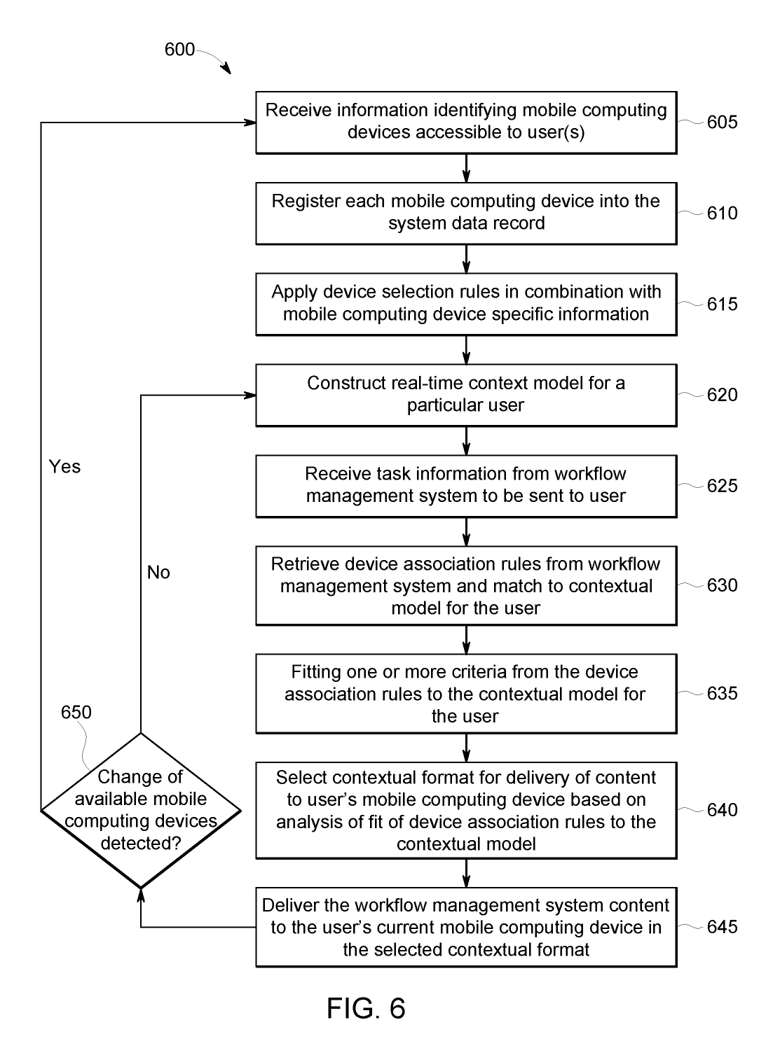

FIG. 6 depicts process 600 for context-sensitive, device-agnostic content delivery in accordance with embodiments. Information identifying one or more mobile computing devices accessible to a user is received, step 605. The information can be managed by device registration unit 143. Each of the mobile computing devices is registered, step 610, into a system data record for that device and that user.

Device selection rules are applied, step 615, in combination with mobile specific device information obtained from datastore records. A real time context model for one or more particular users is constructed, step 620. To construct the model, context model unit 145 can use contextual data records, device selection rules, environmental factors, a device taxonomy, and end user status information. Task information for a pending task is received, step 625, from the workflow management system. The task information identifies the specific end user that is to receive the data.

Device association rules are retrieved, step 630, from the workflow management system. The criteria specified in the device association rules is fitted, step 635, to one or more contextual models constructed for the end user mobile computing device. The particular contextual model for delivery of the content is selected, step 640, based on an evaluation of the model's fit to the device association rules. The content is delivered, step 645, to the end user in the selected contextual format. After completing content delivery of a current workflow task (step 645), if there are additional workflow tasks process 600 continues to step 650. In accordance with embodiments, if there is a change of available mobile computing devices (e.g., new devices added and/or existing devices removed), as detected at step 650, the process continues to step 605. Otherwise, the process continues to step 620 where a contextual model for the next workflow task is calculated. The task information content to be delivered can be updated to reflect available mobile computing devices, their specific information, and the next workflow task. If the workflow has no further tasks after step 645, process 600 terminates.

In accordance with embodiments, a computer program application stored in non-volatile memory or computer-readable medium (e.g., register memory, processor cache, RAM, ROM, hard drive, flash memory, CD ROM, magnetic media, etc.) may include program code and/or computer executable instructions that when executed may instruct and/or cause a controller or processor to perform methods discussed herein such as a method for context-sensitive, device-agnostic delivery of workflow management system content, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A method for contextual content delivery of workflow management system information to a mobile computing device, the method comprising:
receiving information identifying at least one mobile computing device accessible to a respective particular user;
registering each of the identified mobile computing device into a respective datastore record, the datastore record associated with the respective particular user;
applying device selection rules in combination with specific information of the mobile computing device;
constructing a real time context model for the respective particular user and at least one of the identified mobile computing devices accessible to the respective particular user;
receiving task information content from the workflow management system to be sent to the respective particular user;
retrieving one or more device association rules from the workflow management system;
fitting one or more criteria of the device association rules to the real time context model;
selecting a context model for delivery of the task information content;
delivering the task information content to at least one mobile computing device accessible to the respective particular user; and
updating the task information content based on mobile computing device specific information and a next workflow task.

2. The method of claim 1, the constructing step including accessing at least one of contextual data records, device selection rules, environmental factors, a device taxonomy, and end user status information.

3. The method of claim 1, the constructing step including accessing mobile computing device specific records containing device specific communication protocol and capability information.

4. The method of claim 1, including providing a dynamic user interface for specifying mobile computing device specific information to be stored in a datastore record.

5. The method of claim 1, the selecting step including determining a contextual format based on one or more capabilities of the mobile computing device.

6. The method of claim 1, including capturing in the real time context model at least one of the respective particular user current status and one or more environmental factors proximate to the respective particular user.

7. The method of claim 6, including updating the real time context model over a period of time to incorporate changes to the respective particular user current status and the one or more proximate environmental factors.

8. The method of claim 1, including determining a current status of the respective particular user by analyzing information from at least one of the workflow management system, mobile computing device sensors, and environmental sensors.

9. A non-transitory computer readable medium containing computer-readable instructions stored therein for causing a control processor to perform a method for contextual content delivery of workflow management system information to a mobile computing device, the method comprising:
receiving information identifying at least one mobile computing device accessible to a respective particular user;
registering each of the identified mobile computing device into a respective datastore record, the datastore record associated with the respective particular user;
applying device selection rules in combination with specific information of the mobile computing device;
constructing a real time context model for the respective particular user and at least one of the identified mobile computing devices accessible to the respective particular user;
receiving task information content from the workflow management system to be sent to the respective particular user;
retrieving one or more device association rules from the workflow management system;
fitting one or more criteria of the device association rules to the real time context model;
selecting a context model for delivery of the task information content;
delivering the task information content to at least one mobile computing device accessible to the respective particular user; and
updating the task information content based on mobile computing device specific information and a next workflow task.

10. The non-transitory computer readable medium of claim 9 containing computer-readable instructions stored therein to cause the control processor to perform the constructing step by including accessing at least one of contextual data records, device selection rules, environmental factors, a device taxonomy, and end user status information.

11. The non-transitory computer readable medium of claim 9 containing computer-readable instructions stored therein to cause the control processor to perform the constructing step by including accessing mobile computing device specific records containing device specific communication protocol and capability information.

12. The non-transitory computer readable medium of claim 9 containing computer-readable instructions stored therein to cause the control processor to perform the method by including providing a dynamic user interface for specifying mobile computing device specific information to be stored in a datastore record.

13. The non-transitory computer readable medium of claim 9 containing computer-readable instructions stored therein to cause the control processor to perform the selecting step by including determining a contextual format based on one or more capabilities of the mobile computing device.

14. The non-transitory computer readable medium of claim 9 containing computer-readable instructions stored therein to cause the control processor to perform the method by including capturing in the real time context model at least one of the respective particular user current status and one or more environmental factors proximate to the respective particular user.

15. The non-transitory computer readable medium of claim 14 containing computer-readable instructions stored therein to cause the control processor to perform the method by including updating the real time context model over a period of time to incorporate changes to the respective particular user current status and the one or more proximate environmental factors.

16. The non-transitory computer readable medium of claim 9 containing computer-readable instructions stored therein to cause the control processor to perform the method by including determining a current status of the respective particular user by analyzing information from at least one of the workflow management system, mobile computing device sensors, and environmental sensors.

17. A system for contextual content delivery of workflow management system information to a mobile computing device, the system comprising:
a server including a control processor, the server in communication with a datastore across an electronic communication network;
the server including:
a device registration unit configured to interface with the workflow management system to manage mobile computing device integration into the system;
a context model unit configured to construct a real time context model incorporating a user current status with one of more environmental factors proximate to the user;
a monitor and inference engine unit configured to determine a mobile computing device for contextual content delivery of information from the workflow management system, the determined mobile computing device selected from among mobile computing devices accessible to the user;
the control processor configured to access computer readable executable instructions that cause the control processor to perform a method including:
receiving information identifying at least one mobile computing device accessible to a respective particular user;
registering each of the identified mobile computing device into a respective datastore record, the datastore record associated with the respective particular user;
applying device selection rules in combination with specific information of the mobile computing device;
constructing a real time context model for the respective particular user and at least one of the identified mobile computing devices accessible to the respective particular user;
receiving task information content from the workflow management system to be sent to the respective particular user;
retrieving one or more device association rules from the workflow management system;
fitting one or more criteria of the device association rules to the real time context model;
selecting a context model for delivery of the task information content;
delivering the task information content to at least one mobile computing device accessible to the respective particular user; and
updating the task information content based on mobile computing device specific information and a next workflow task.

18. The system of claim 17, the computer-readable instructions including instructions to cause the control processor to perform the constructing step by including accessing at least one of contextual data records, device selection rules, environmental factors, a device taxonomy, end user status information, and mobile computing device specific records containing device specific communication protocol and capability information.

19. The system of claim 17, the computer-readable instructions including instructions to cause the control processor to perform the method by including:
capturing in the real time context model at least one of the respective particular user current status and one or more environmental factors proximate to the respective particular user; and
updating the real time context model over a period of time to incorporate changes to the respective particular user current status and the one or more proximate environmental factors.

20. The system of claim 17, the computer-readable instructions including instructions to cause the control processor to perform the method by including determining a current status of the respective particular user by analyzing information from at least one of the workflow management system, mobile computing device sensors, and environmental sensors.
